(19) United States
(12) Patent Application Publication
(10) Pub. No.: US 2026/0268799 A1
(43) Pub. Date: Sep. 10, 2026

(54) PLATFORM FOR EVALUATING TRUST IN AI-BASED BIOMEDICAL TOOLS

(71) Applicant: University of Connecticut, Farmington, CT (US)

(72) Inventors: Hugo F. Posada-Quintero, Storrs, CT (US); Javier O. Pinzon-Arenas, Storrs, CT (US); Amir Mohammad Karimi Forood, Storrs, CT (US); Josef Kundrat, Storrs, CT (US); Boluwatife E. Faremi, Storrs, CT (US); Wendy A. Henderson, Philadelphia, PA (US)

(73) Assignee: University of Connecticut, Farmington, CT (US)

(21) Appl. No.: 19/558,833

(22) Filed: Mar. 6, 2026

Related U.S. Application Data
(60) Provisional application No. 63/768,061, filed on Mar. 6, 2025.

(51) Int. Cl. G09B 23/28; G06Q 10/0639

(52) U.S. Cl. CPC G09B 23/28; G06Q 10/0639

(57) ABSTRACT

An apparatus includes at least one processor, and at least one memory storing instructions that, when executed by the at least one processor, cause the apparatus at least to: generate video-based simulations of clinical nursing scenarios, present the video-based simulations of the clinical nursing scenarios to a user, wherein the video-based simulations of the clinical nursing scenarios comprise artificial intelligence recommendations that are presented to the user, capture physiological signals of the user based on physiological responses of the user while the user makes decisions in response to the video-based simulations of the clinical nursing scenarios comprising the artificial intelligence recommendations, determine, based on the physiological signals, trust levels that indicate levels at which the user trusts the artificial intelligence recommendations, and determine performance data indicative of a performance of the user while the user interacts with the video-based simulations of the clinical nursing scenarios.

### CROSS-REFERENCE TO RELATED APPLICATIONS

This application claims priority to U.S. Provisional Application No. 63/768,061, filed Mar. 6, 2025, the contents of which are incorporated by reference herein in their entirety.

### BACKGROUND

### 1. Technical Field

The examples described herein relate to learning tools, and in particular to monitoring systems for evaluating the efficacy of AI healthcare technology systems (AIHTs).

### 2. Description

AI is revolutionizing healthcare and medical education by enabling automated assessments, personalized learning, real-time content updates, clinical simulations, and adaptation of educational materials to reflect current research and practice. This technological shift comes at a time when the traditional method of medical education faces significant challenges, such as limited hands-on experience, inconsistent mentoring, and the burden on students to memorize and replicate complex real-world scenarios taught in resource-constrained settings. Trust in AI has been identified as essential to the successful adoption of AI in health professional education. Trust in technology has been investigated from a psycho-physiological perspective across diverse domains from driving simulation to virtual reality and collaborative robotics. Yet, a significant gap exists in the nursing field, as no technology has addressed nurses' trust in biomedical AI tools. What is needed is a platform for measuring and monitoring trainee nurses' trust in AI healthcare technology systems (AIHTs).

Existing approaches to assessing trust in AI tools for learning and guiding trainees in patient outcomes have largely depended on expert supervisors, educators, or clinicians, who can swiftly determine the relevance and applicability of AI-generated outputs—an ability that novice learners may lack. Regardless of expert validation, it has been observed that trainees may either underuse AI tools due to distrust or become overly reliant on them, potentially leading to professional deskilling. Therefore, to effectively integrate AI into medical training, there is a critical need for AIHTs that can measure and monitor trainee trust in AI tools within healthcare education. This is essential because understanding trainee trust levels will allow educators to design tailored learning pathways, identify strengths and weaknesses in knowledge, and reinforce critical concepts before trainees interact with real patients.

Defining trust is complex due to variations in interpretation across different fields. Nonetheless, trust may be defined as the willingness of a party to be vulnerable to the actions of another party based on the expectation that the other will perform a particular action important to the trustor, irrespective of the ability to monitor or control that other party. The complexity of human-AI interaction necessitates examining trust across three dimensions: dispositional, situational, and learned trust. Dispositional trust is a stable tendency to trust AI, shaped by personality traits and past experiences. Situational trust, by contrast, is dynamic and context-dependent, influenced by system complexity, task difficulty, and perceived risk. Learned trust develops through direct interactions with AI, updating over time based on experience. In healthcare, which is the focus of the examples described herein, trust measurement primarily relies on situational trust, as users assess AI based on real-time performance and perceived reliability. Nevertheless, across all types of trust, cognition plays a crucial role in shaping trust through beliefs, prior experiences, and continuous reassessment based on new information.
Trust may be assessed from a psycho-physiological perspective since it carries a cognitive component. Trust's manifestation in the human body is the result of a complex series of physiological events. One related connection can be seen by changes in a person's skin conductance because of changes in stress level associated with trust. Skin conductance changes captured by electrodermal activity (EDA) are not under conscious control but rather are altered by the sympathetic innervation of sweat glands, which causes an increase in sweating production. It is important to mention that EDA is also called galvanic skin response. Continuous monitoring of EDA has been widely explored in many settings, including monitoring pain, stress, fatigue, and trust. Several recent studies have investigated the link between trust and EDA, showing that lower trust correlates with higher EDA. EDA of users of a text chat environment strongly affected by trust and cognitive load. EDA to assess trust.

Measuring trust in AI and automated systems may be implemented. The examples described herein are directed to nurses interacting with AI healthcare tools, these methods build upon prior research in related domains. Trust in automative sensors was evaluated using EEG and EDA during simulated driving tasks. Similarly, EDA and EEG may be combined to assess trust and cognitive load in virtual reality environments, demonstrating the versatility of these physiological measures across different interaction modalities. In the domain of robotics, EDA may be a primary physiological marker for indicating trust in human-robot collaboration. Most relevant to a focus on healthcare, the impact of enhanced factual explanations on trust in AI systems may be manifested with both blood volume pressure and EDA.

The AIHT platform disclosed herein extends these methodologies into the critical healthcare education context, where accurate trust calibration has direct implications for patient care, while preserving the proven effectiveness of EDA as a trust indicator across various human-AI interaction scenarios.

### SUMMARY

In an embodiment, an apparatus includes at least one processor and at least one memory storing instructions that, when executed by the at least one processor, cause the apparatus at least to: generate video-based simulations of clinical nursing scenarios; present the video-based simulations of the clinical nursing scenarios to a user, wherein the video-based simulations of the clinical nursing scenarios comprise artificial intelligence recommendations that are presented to the user; capture physiological signals of the user based on physiological responses of the user while the user makes decisions in response to the video-based simulations of the clinical nursing scenarios comprising the artificial intelligence recommendations; determine, based on the physiological signals, trust levels that indicate the extent to which the user trusts the artificial intelligence recommendations; and determine performance data indicative of the user's performance while interacting with the video-based simulations of the clinical nursing scenarios.

In another embodiment, a method includes generating video-based simulations of clinical nursing scenarios; presenting the video-based simulations of the clinical nursing scenarios to a user, wherein the video-based simulations of the clinical nursing scenarios comprise artificial intelligence recommendations that are presented to the user; capturing physiological signals of the user based on physiological responses of the user while the user makes decisions in response to the video-based simulations of the clinical nursing scenarios comprising the artificial intelligence recommendations; determining, based on the physiological signals, trust levels that indicate the extent to which the user trusts the artificial intelligence recommendations; and determining performance data indicative of the user's performance while interacting with the video-based simulations of the clinical nursing scenarios. Generating the video-based simulations of the clinical nursing scenarios is performed with a healthcare technology platform, and the healthcare platform can take expert instruction and generate text-video simulations that have AI recommendations, and the video-based simulations of the clinical nursing scenarios include the text-video simulations that have the AI recommendations.

In yet another embodiment, a system includes a healthcare technology platform configured to generate video-based simulations of clinical nursing scenarios and present the video-based simulations of the clinical nursing scenarios to a user, wherein the video-based simulations of the clinical nursing scenarios comprise artificial intelligence recommendations that are presented to the user using the healthcare technology platform; a real-time physiological module configured to measure physiological signals of the user based on physiological responses of the user while the user makes decisions in response to the video-based simulations of the clinical nursing scenarios comprising the artificial intelligence recommendations, wherein the real-time physiological module is configured to determine, based on the physiological signals, trust levels that indicate the extent to which the user trusts the artificial intelligence recommendations; and a real-time performance data module configured to determine performance data indicative of the user's performance while interacting with the video-based simulations of the clinical nursing scenarios. The healthcare platform can take expert instruction and generate text-video simulations that have AI recommendations, and the video-based simulations of the clinical nursing scenarios include the text-video simulations that have the AI recommendations.

### BRIEF DESCRIPTION OF THE DRAWINGS

FIG. 1 shows a closed-loop platform for evaluating trust in AI-based healthcare technologies.

FIG. 2 shows an example configuration of an artificial intelligence healthcare technology, AIHT, platform for trainee use.

FIG. 3 depicts an example implementation of an AIHT platform experiment page showing courses of action that can be taken by a trainee nurse after a recommendation.

FIG. 4 is a graph showing sample real-time physiological data processed by a real-time physiological module for trust assessment level.

FIG. 5A shows sample real-time performance and reaction time processed by a real-time performance data module.

FIG. 5B shows sample real-time performance and reaction time processed by a real-time performance data module.

FIG. 6 shows an instance of use by a trainee nurse.

FIG. 7 shows an open-loop platform for evaluating trust in AI-based healthcare technologies.

FIG. 8 is an example apparatus configured to implement the examples described herein.

FIG. 9 shows a representation of an example of non-volatile memory media used to store instructions that implement the examples described herein.

FIG. 10 is an example method that implements the examples described herein.

### DETAILED DESCRIPTION

Disclosed herein is a platform that addresses the identified gap in medical education by measuring and monitoring trainee nurses' trust in AIHT, by integrating a set of simulated scenarios and simultaneous collection of EDA signals. The AIHT provides an assessment of the relationship between trust and nurse-AIHT performance, reducing reliance on expert judgment alone for evaluating trust in AIHT technologies. Its potential benefit lies in fostering appropriate trust among trainees, enabling them to make critical decisions effectively in fast-paced real-life scenarios. The platform and preliminary validation of the platform are presented in the following section.

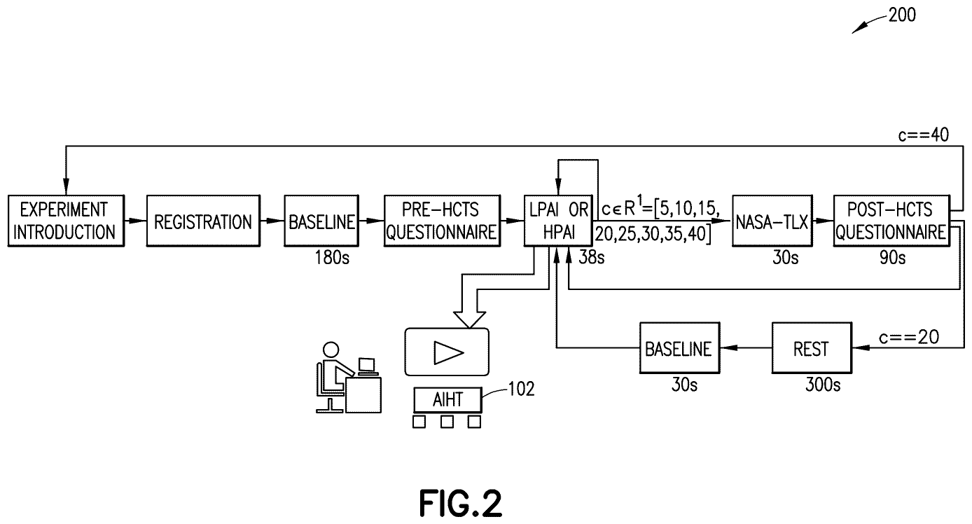

Generally, the AIHT platform disclosed herein is an interactive system designed to assess nurses' decision-making and trust in AI-assisted healthcare scenarios. Participants watch realistic, custom-designed video scenarios where they must decide on a course of action-using an AED, administering NARCAN, or doing nothing-based on an AI system's recommendation. The platform measure's reaction time provides immediate feedback on decision accuracy and evaluates trust using the Human-Computer Trust Scale (HCTS) and workload demands via the NASA-TLX questionnaire. To examine the impact of AI performance on trust, the platform allows the participants to interact with both high-performance (HPAI) and low-performance (LPAI) AI systems across 40 scenarios, with randomized exposure order. An example configuration of an AIHT platform is illustrated in FIG. 2. A more detailed description of the AIHT platform is provided below.

AIHT Platform Design: The platform presents the participant a series of realistic scenarios illustrated with videos. The videos depict a realistic scenario illustrated with vignettes in which a nurse ultimately had to make a critical decision with the assistance of an AI system. A pool of 50 scenarios were designed. For this implementation, the participant has three options: automated external defibrillator (AED), administer NARCAN, or do nothing. These videos were custom-designed by members of the research team from the UConn School of Nursing to mimic nursing-related events that commonly incorporated AI technology. For example, in a given scenario a patient has a deteriorating condition and it's important to decide if cardiopulmonary resuscitation is needed. Given the specifics of the situation, the AI system recommends using the AED. Then, the participant must choose to follow the AIHT suggestion or choose another option. The participant receives a response notifying them of the “correctness” of their answer (the patient survived or not).

The AIHT platform also assesses human-computer trust using the HCTS, which measures perceptions of benevolence, competence, and perceived risk in human-technology interactions. Additionally, the AIHT platform includes the NASA-TLX questionnaire after each testing group to evaluate workload demands while performing the task. Given that trust is affected by AI performance, high-performance AI (HPAI) systems and low-performance AI (LPAI) systems may be designed. Each participant interacted with an HPAI and an LPAI system for 20 scenarios each. Participants will be randomly assigned to interact first with either the HPAI or LPAI systems. There will be a break between the interaction with the first AI system and the second AI system. As each scenario lasts approximately 38 seconds, the total procedure takes about 60 minutes, accounting for training and downtime between scenarios.

AIHT Platform Implementation. The AIHT platform design follows a simplistic two-layer web architecture topology. The web architecture topology combines three components of application, presentation, processing, and database in two modalities on a machine with specifications Intel® Core™ Ultra, 32 Gb RAM, 3.8 GHz processor speed, Windows 11 operating system, Apache 2.4.54 server and Oracle Database 18c Express Edition Production. Bootstrap 5 framework containing user interface (UI) components such as HTML, CSS, JavaScript, AJAX and PHP were used to render and control logic of the experiments presented to the participants and investigators. Below is an example pseudocode 1 for the AIHT platform.

Pseudocode 1:

```
START Experiment
SET numberOfExperiments = 40
SET count = 0
WHILE count < numberOfExperiments DO
  Play vignettes
  AIHT offers recommendations
  Participant decides and gets a response
  IF count is in [5, 10, 15, 20, 25, 30, 35, 40]
  THEN
    IF count == 20 THEN
      Participant fills NAS-TLX
      Participant fills HCTS
      Participant takes a break
    ELSE IF count == 40 THEN
      Participant fills NAS-TLX
      Participant fills HCTS
      Start new experiment
    ELSE
      Participant fills NAS-TLX
      Participant fills HCTS
    ENDIF
  ENDIF
    INCREMENT count
  ENDWHILE
```

Physiological Recording. The Empatica Embrace Plus watch may be used for acquisition of EDA. It has a range of 0.01-100 microsiemens, resolution of 1 digit-900 pico Siemens and at a sampling frequency of 4 Hz.

AIHT Platform Validation. Validation of the platform will include recruiting of nursing students, at sophomore, or junior level. Individuals who use stimulants such as caffeine will be excluded. For preliminary validation of this platform, data of one participant will be presented to show the efficacy of the AIHT platform. Upon arrival at the lab, the participants were informed about the purpose and given consent forms. After providing consent, they were registered on the AIHT platform.

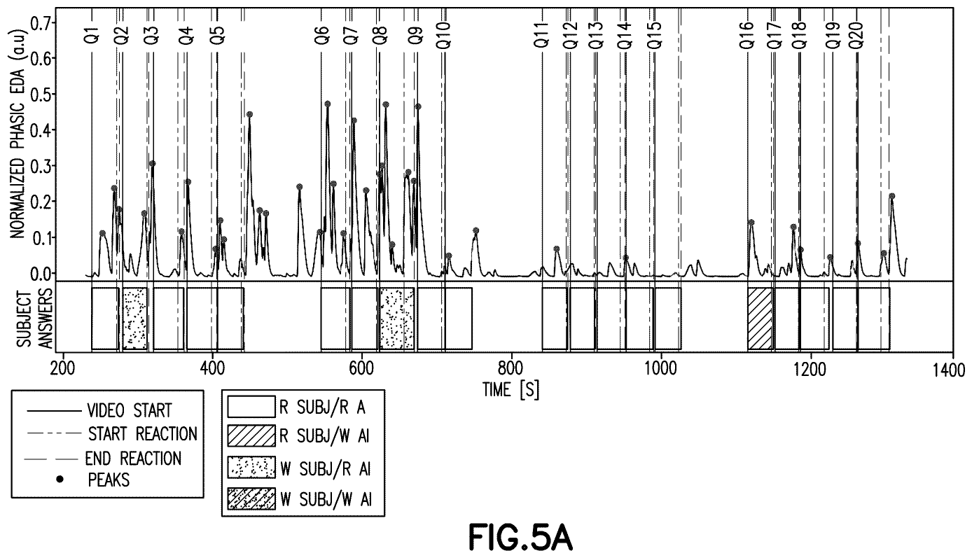

Signal Processing. Data comprised of acquired EDA signals, trust-influenced reaction times, and cognitive performance of trainee nurses during experiments are analyzed. Raw EDA signals were processed using a 5-second window median filter for smoothing, followed by a low pass FIR filter of 1 Hz to remove high-frequency components. The cleaned signal was then decomposed into tonic (slowly varying) and phasic (rapidly changing) components using the cvxEDA technique. The EDA response from a participant during interaction with a HPAI is shown in FIGS. 5A and 5B. The HPAI has 95% of accuracy in their recommendations. During this phase, an average of 34 EDA peaks were observed, and the participant exhibited a 90% of accuracy in their responses. The average reaction time was 4.75 seconds. This suggests that the AIHT system's high accuracy fostered trust, leading to strong performance (FIG. 5A). After a five-minute rest period, the participants interacted with a LPAI with an accuracy of 60% in their recommendations. This phase resulted in a 30% increase in EDA peaks compared to the trust-building phase, potentially indicating increased cognitive effort due to the AIHT's reduced reliability. Simultaneously, performance accuracy of the participant dropped by 50%, suggesting that diminished AI accuracy weakened trainee nurses' trust, negatively affecting their performance (FIG. 5B).

This analysis resulted in a platform for assessing trainee nurses' trust in AI healthcare technology systems. As observed, the integration of physiological signals such as EDA with behavioral measures may offer valuable insights into trust dynamics in healthcare AI interactions. The observed differences in EDA response patterns, reaction times, and accuracy between interactions with high-performance and low-performance AI systems align with current understanding of trust formation. These preliminary observations align with physiological markers of trust being reliable and generalizable.

The AIHT platform's integration of realistic video scenarios with physiological monitoring offers a promising approach for future research and potential applications in nursing education. As AI systems become increasingly prevalent in healthcare settings, understanding the factors that influence appropriate trust calibration will be essential for effective human-AI collaboration.

The platform supports personalized difficulty adjustments to optimize learning outcomes. Different AI explanation styles may influence trust formation and decision quality in healthcare contexts, building on existing frameworks for AI integration in health professions education.

AI-based biomedical engineering tools are increasingly being used to address critical challenges in various aspects of healthcare, from diagnostics to therapeutics. While AI offers immense potential to improve clinical decision making, the trust of intended users (e.g., nurses and physicians) in these systems remains largely unexplored. The platform described herein addresses the gap in medical education including by investigating how nursing students interact with and trust AI recommendations in realistic healthcare scenarios. Based on a multidisciplinary collaboration of experts in biomedical engineering, nursing, psychology, and simulation, described herein is a virtual platform for simulating healthcare tools to assess students' trust in AI recommendations using custom-designed scenarios illustrated with video vignettes. Using different AI systems with varying levels of performance and combinations of correct and incorrect suggestions, the platform is designed to provide an in-depth exploration of these trust dynamics in realistic healthcare settings. The platform allows the collection of participants' trust levels, cognitive loads, reaction times, and physiological reactions throughout the experiment using validated tools. Physiological measures, particularly electrodermal activity, aim to capture the effect of trust in the emotions of the participants. The platform enables researchers to determine how different AI performance and scenario complexity affect trust, decision making, and cognitive load for users, and can help inform the development of future targeted educational interventions aimed at optimizing the integration of AI into healthcare education and practice.

Described herein is a platform designed to generate nurse-AI healthcare technology (AIHT) interaction, assess the levels of trust and cognitive load of the nurses, and optimize performance in nurses that assist in life-threatening decision-making. The system utilizes objective physiological signals like electrodermal activity data to quantify nurses' trust in AI-generated recommendations. An intelligent algorithm dynamically personalizes life-critical scenarios based on individual performance, analyzing decisions to trust, distrust, or take alternative actions. By continuously adapting to user responses, the platform enhances trust calibration, mitigates overreliance or underuse of AI, and improves decision-making effectiveness in high-stakes medical environments.

The primary end users of the system described herein are healthcare professionals, particularly nurses or doctors and trainee clinicians, who rely on AI-driven healthcare technologies for decision-making in life-threatening scenarios.

The platform is designed for use by medical trainees, nurses, educators, and clinical supervisors in medical training programs, hospitals, and simulation-based learning environments.

The herein described platform is designed to directly measure and optimize healthcare professionals' performance and trust simultaneously in AI-driven decision-support systems using physiological signals. While AI-assisted training tools and immersive learning platforms may create engaging medical training scenarios, they do not aim to dynamically assess or personalize trust calibration in AI recommendations for life-critical decision-making.

The examples described herein improve the integration of AI in medical education by addressing a significant gap in measuring trust and optimizing healthcare professionals' performance among trainee nurses. Unlike traditional approaches that rely solely on expert supervision and subjective assessments, this platform provides objective, real-time trust evaluation using physiological signals and AI-driven scenario personalization.

The platform described herein enhances decision-making, ensuring that nurse trainees develop balanced trust in AI recommendations, preventing overreliance and distrust, which could impact patient outcomes. It also reduces training inefficiencies, reducing the burden on educators and trainers while offering personalized learning pathways tailored to individual trust levels. Ultimately, the platform described herein improves patient safety and provides data-driven insights for clinical practice and research, by helping trainees calibrate their trust in AI, leading to more confident and effective decision-making in high-pressure, life-critical situations.

AI-assisted training platforms enhance medical education by using immersive virtual reality (VR), artificial intelligence, and data-driven analytics to create engaging, simulated training environments. While interactive learning experiences may be provided, general interactive learning experiences lack the capability to objectively measure and optimize healthcare professionals' trust and performance simultaneously-a crucial factor in AI adoption within medical decision-making.

The platform described herein provides objective trust and performance measurement, provides AI-driven personalization of training scenarios, prevents AI overreliance and underuse, provides real-time data analytics for educators, and bridges a critical research gap in nursing AI training.
1. Objective Trust and Performance Measurement. Rather than primarily focusing on skill-building and engagement, the examples described herein integrate real-time physiological signals (such as electrodermal activity) to quantify trust in AI healthcare technologies. The platform continuously tracks how nurses trust level on AI-generated recommendations and correlates this trust with their decision-making performance in life-threatening scenarios.
2. AI-Driven Personalization of Training Scenarios. Rather than just offering standardized training experiences, the system described herein dynamically adapts simulated scenarios based on each trainee's trust level and past decision-making behavior. The platform adjusts the complexity, urgency, and AI interaction within each case to ensure nurses develop balanced trust and critical thinking in high-stakes situations.
3. Prevention of AI Overreliance and Underuse. One of the critical challenges in AI adoption is the risk of either excessive reliance or complete distrust in AI-driven recommendations. The system described herein identifies patterns of overreliance or skepticism and intervenes with tailored feedback to help trainees develop appropriate trust calibration, something Virti does not address.
4. Real-Time Data Analytics for Educators. Instead of relying on post-training assessments, the system described herein provides continuous, real-time data on both trust levels and clinical decision-making performance to educators. These insights enable instructors to design highly personalized learning pathways, strengthening AI-assisted decision-making in real-world applications.
5. Bridging a Critical Research Gap in Nursing AI Training. Existing AI-assisted training tools, including Virti, focus on general medical skill development rather than trust in AI-powered decision-support systems. The herein described platform directly measures and optimizes trust and performance in AI-driven healthcare technologies for nurses, ensuring safe, efficient, and AI-enhanced patient care.

### Closed-Loop System

A closed-loop system is a dynamic system that uses feedback to self-regulate and maintain optimal performance. Described herein a closed-loop AI-driven system for measuring and optimizing healthcare professionals' trust and performance in AI-assisted decision-making. The system continuously acquires physiological signals to quantify trust levels and performance data to evaluate clinical decision-making. This real-time feedback loop enables the system to adjust AI recommendation patterns dynamically based on the trainee nurse's responses, ensuring balanced trust calibration and improved decision accuracy. By integrating the adaptive scenario modeling, the system personalizes training experiences, mitigating risks associated with AI overreliance and distrust in high-stakes medical environments.

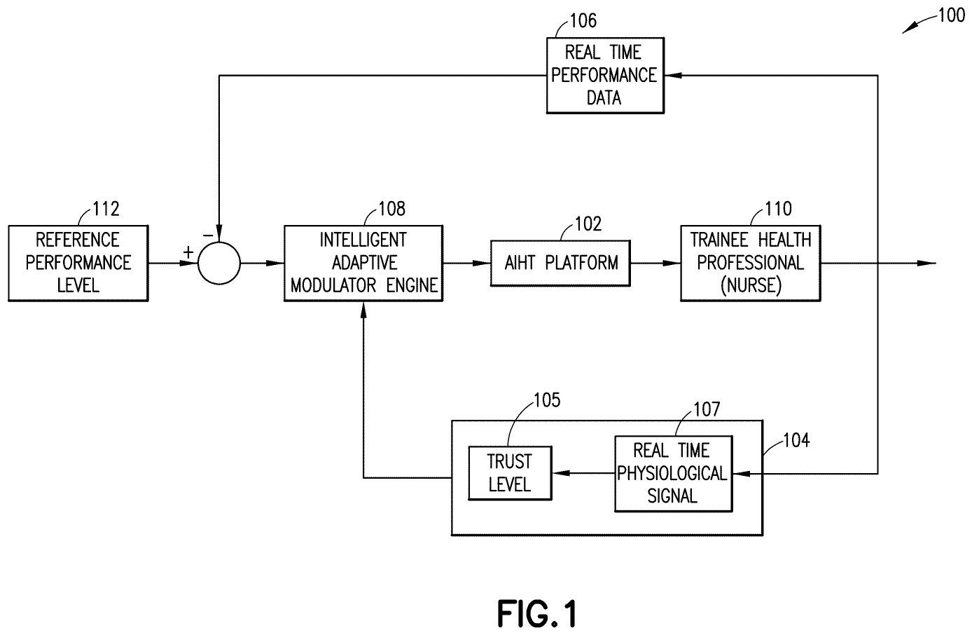

FIG. 1 shows a closed-loop platform 100 for evaluating trust in AI-based healthcare technologies. The architecture of the closed-loop platform consists of an AIHT platform 102, a real-time physiological module 104, a real-time performance data module 106, an intelligent adaptive modulator engine 108, a trainee health professional (Nurse) 110, and a reference performance module 112.
1. The AIHT Platform 102 is a computer system that generates and presents video-based simulations of clinical nursing scenarios, wherein an artificial intelligence (AI) system of the AIHT platform 102 provides decision support. The simulations include but are not limited to, scenarios requiring selection between interventions such as automated external defibrillator (AED) deployment, NARCAN administration, and inaction. Depending on use, the AIHT Platform 102 is configured to: i) adapt scenario quantity and session duration based on supervisor-defined parameters, ii) present scenarios utilizing high-performance AI (HPAI) and low-performance AI (LPAI) response sets, with randomized presentation order, iii) measure human-computer trust using the Human-Computer Trust Scale (HCTS), iv) quantify participant workload using the NASA-TLX questionnaire, and v) provide/withhold immediate outcome feedback based on trainee nurse response to simulated scenarios.

The example pseudocode 2 below and FIG. 2 provide a technical setup of the platform depending on use. FIG. 2 depicts an implemented AIHT Platform 102, and an example configuration 200 of the AIHT platform 102 for trainee use.

Pseudocode 2:

```
START Experiment
SET numberOfExperiments = N
SET count = 0
WHILE count < numberOfExperiments DO
  Play vignettes
  AIHT offers recommendations
  Participant decides and gets a response
  IF count is in [5, 10, ..., N]
  THEN
    IF count == N/2 THEN
      Participant fills NAS-TLX
      Participant fills HCTS
      Participant takes a break
    ELSE IF count == N THEN
      Participant fills NAS-TLX
      Participant fills HCTS
      Start new experiment
    ELSE
      Participant fills NAS-TLX
      Participant fills HCTS
    ENDIF
  ENDIF
    INCREMENT count
ENDWHILE
```

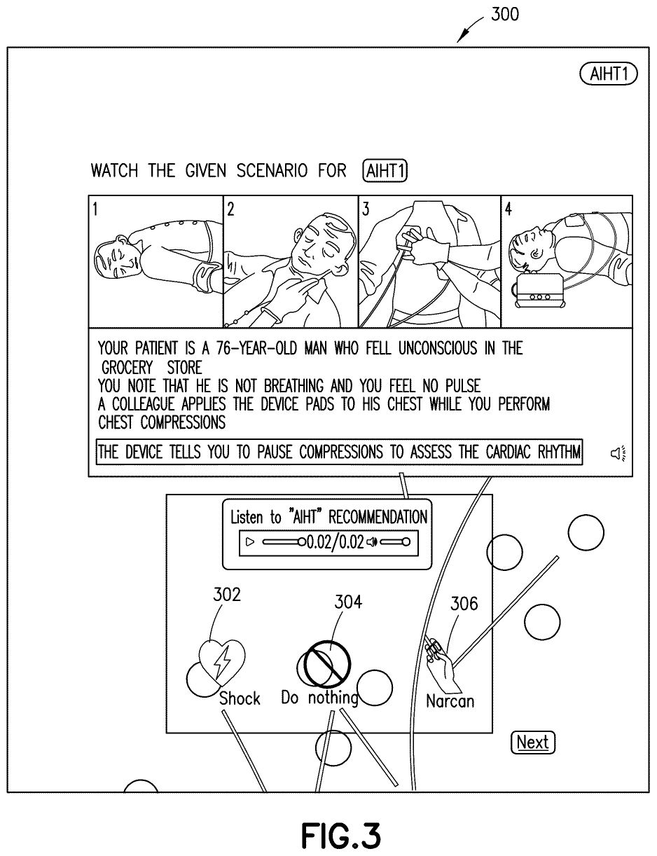

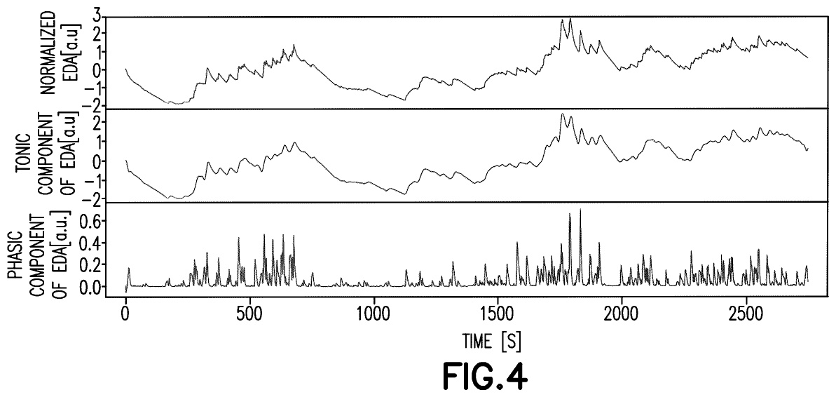

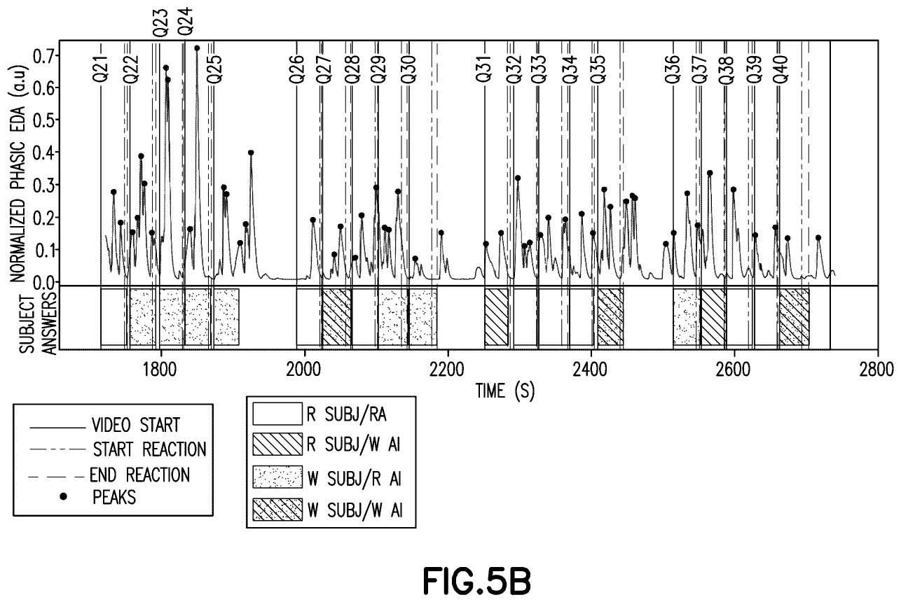

FIG. 3 shows an example implementation of an AIHT Platform experiment page 300 showing courses of action (302, 304, 306) that can be taken by the trainee nurse after a recommendation.
2. The Real-time Physiological Module 104 is a computer-implemented module configured to continuously acquire, record, and analyze physiological signals 107 from a trainee nurse (namely trainee health professional (nurse) 110) via wireless communication protocols, such as Bluetooth, to objectively assess trainee nurse trust and cognitive state during artificial intelligence (AI)-assisted decision-making. Refer to FIG. 4, which shows sample real-time physiological data processed by the real-time physiological module 104 to generate the trust assessment level 105. The real-time physiological module 104 comprises: i) A physiological acquisition unit, including wearable biosensors, configured to capture physiological indicators, including but not limited to electrodermal activity (EDA) and heart rate variability (HRV), wherein said indicators are correlated with participant stress, cognitive load, and trust dynamics, ii) A data synchronization component configured to temporally align acquired physiological data with participant interactions occurring within simulated AI-assisted decision-making scenarios, iii) An analysis component configured to process and detect fluctuations in participant trust based on interactions with high-performance AI (HPAI) and low-performance AI (LPAI) systems generates objective measures of trust calibration, iv) A data transmission component configured to transmit processed physiological data to an Intelligent Adaptive Modulator Engine 108, wherein the intelligent adaptive modulator engine 108 dynamically adjusts training scenarios based on real-time physiological and performance data.
3. The Real-time Performance Data Module 106 is a computer-implemented module configured to continuously capture, process, and analyze participant performance metrics during AI-assisted decision-making. The real-time performance data module 106 is designed to quantify reaction time, performance scores, behavioral responses, and cognitive scores, providing real-time assessments of decision-making effectiveness. FIG. 5A and FIG. 5B show sample real-time performance and reaction time processed by the real-time performance data module 106. The real-time performance data module 106 comprises: i) a data acquisition component configured to record participant interactions, including selection response time, decision accuracy, and deviations from expected clinical protocols, ii) a behavioral and cognitive analysis component configured to evaluate decision-making patterns, cognitive workload, and behavioral tendencies, wherein said analysis provides insights into participant competence and reasoning strategies, iii) a performance evaluation component configured to compute performance scores by comparing participant responses against predefined optimal decision criteria, generating a deviation metric indicative of clinical decision proficiency, iv) a data integration component configured to transmit real-time performance metrics to the Intelligent Adaptive Modulator Engine 108, wherein the intelligent adaptive modulator engine 108 dynamically adjusts training scenarios based on participant trust levels and performance discrepancies to optimize AI-assisted decision-making training.
4. The Intelligent Adaptive Modulator Engine 108 is an intelligent, computer-implemented module configured to dynamically adjust AI decision recommendation presentation and scenario difficulty based on participant trust levels (trust level data 105) and performance discrepancies. The intelligent adaptive modulator engine 108 continuously processes real-time physiological trust data (trust level data 105) and performance metrics generated by the real-time performance data 106 to optimize AI-assisted decision-making training. The Intelligent Adaptive Modulator Engine 108 ensures that the AIHT platform 102 continuously refines training difficulty and AI recommendation strategies, fostering appropriate AI trust calibration and improved clinical decision-making performance. The intelligence adaptive modulator engine 108 comprises: i) a trust-performance integration component configured to receive and analyze trust level data 105 from the Real-Time Physiological Module 104 and performance discrepancy metrics from the Real-Time Performance Data Module 106, wherein the combined data is used to assess participant engagement and decision-making tendencies, ii) a scenario adaptation component configured to modulate the presentation of AI-generated recommendations by adjusting factors such as confidence level indicators, explanation transparency, and frequency of AI interventions in response to participant trust calibration needs, iii) a difficulty adjustment component configured to dynamically modify scenario complexity, time constraints, and AI assistance level, ensuring that participants are exposed to progressively challenging decision-making environments tailored to their measured trust-performance balance, and iv) a real-time feedback engine configured to update the training experience based on participant interactions (such as interactions with trainee health professional 110)), ensuring a personalized and adaptive learning trajectory that prevents AI overreliance or distrust and optimizes decision-making effectiveness.
5. Trainee Health Professional (Nurse) 110: The Trainee Health Professional (Nurse) 110 refers to the participant engaging in AI-assisted decision-making training. FIG. 6 shows an instance 600 of use by a trainee health professional (nurse) 110, during which instance of use by the trainee nurse data may be collected such as data comprised of acquired EDA signals and trust-influenced reaction times (collectively real-time physiological data 104), and cognitive performance (of real-time performance data 106) of the trainee health professional (nurse) 110 during experiments. The system monitors and records the following data from the participant, namely the trainee health professional (nurse) 110: i) Physiological Data generated by the real-time physiological module 104: The system continuously acquires physiological signals 107, including electrodermal activity (EDA), heart rate variability (HRV), indicative of the participant's stress, cognitive load, emotional responses, and trust dynamics, ii) Performance Data: The system tracks reaction time, decision accuracy, and problem-solving performance to assess the participant's clinical decision-making abilities, iii) Behavioral and Cognitive Data: The system monitors decision patterns, including whether the participant follows or disregards AI recommendations, and evaluates the participant's trust in AI and decision rationale, iv) AI Interaction Data: The system records interaction frequency and reliance on AI recommendations, assessing the trust and reliance on the AI's suggestions during decision-making. Referring to FIG. 6, the physiological signals of the trainee health professional 110 are received from a wearable biosensor 170 worn by the trainee health professional 110 while the trainee health professional 110 interacts with the video-based simulations of the clinical nursing scenarios shown on the AIHT platform 102.
6. The reference performance module 112 is a computer-implemented module configured to provide a benchmark for evaluating participant performance during AI-assisted decision-making. The Reference Performance Module 112 provides an objective performance baseline, facilitating personalized training adjustments and ensuring participants are evaluated consistently against optimal clinical decision-making standards. The reference performance module 112 comprises: i) a reference performance database which is a repository of predefined performance standards, including ideal decision-making outcomes, optimal response times, and accuracy benchmarks, against which the participant's performance is compared, ii) a Performance Evaluation Component which is a component configured to compare real-time participant data (including reaction time, decision accuracy, and behavioral responses) with the predefined benchmarks from the Reference Performance Database, generating a performance discrepancy score that indicates the participant's deviation from the reference standard, and iii) a Performance Feedback Generator which is a component configured to generate feedback based on the comparison, indicating areas of improvement and reinforcing correct decision-making, thereby supporting the participant's clinical decision-making proficiency.

### Open-Loop System

An open-loop system is a non-feedback-driven system that operates based on predefined parameters without continuous self-regulation. Described herein is an open-loop AI-driven system for measuring and evaluating healthcare professionals' trust and performance in AI-assisted decision-making. The system only acquires physiological signals and performance data to assess clinical decision-making without dynamically adjusting the training scenarios.

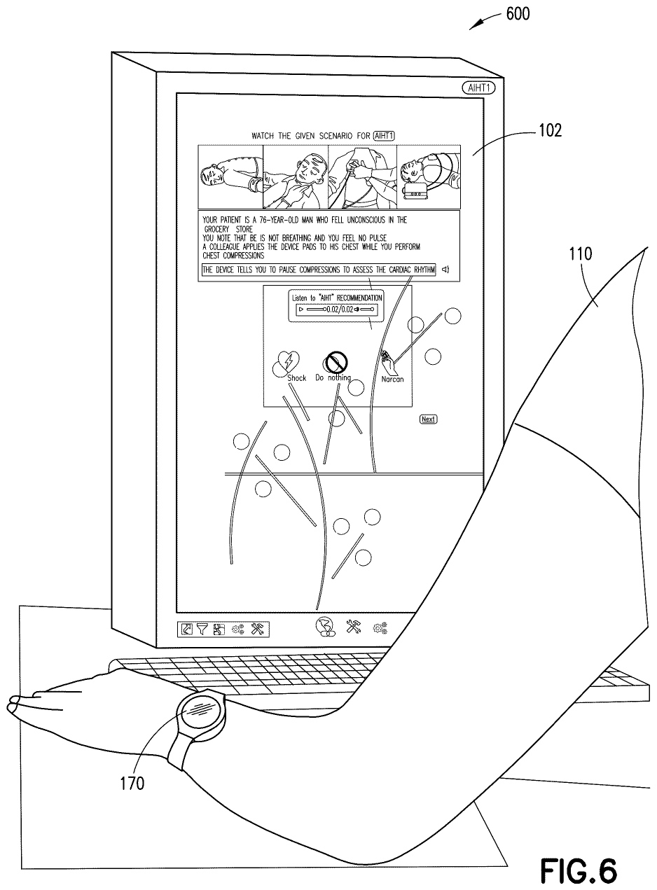

FIG. 7 shows the architecture of an open-loop system 700 consisting of the following components: the AIHT platform 102, the trainee health professional (nurse) 110, real-time physiological module 104 that does physiological measurement, and the real-time performance data module 106 that assesses performance data.
1. The AIHT Platform 102 is a system configured to present a series of predefined clinical scenarios to the trainee healthcare professional. These scenarios involve AI-assisted decision-making, where the trainee health professional (nurse) 110 is presented with AI recommendations, but unlike in the closed loop system 100, in the open loop system 700 the AIHT platform 102 does not adjust or alter the AI recommendation presentation or training based on real-time performance data generated by the real-time performance data module 106 or trust level data 105 generated by the real-time physiological module 104.
2. The Trainee Health Professional (Nurse) 110 is the participant, typically a trainee healthcare professional (such as a nurse), that interacts with the AIHT platform 102 by making decisions based on the AI's recommendations. The responses of the trainee health professional (nurse) 110 are recorded, but the system (namely the AIHT platform 102) does not adjust its behavior, or the scenarios based on these interactions with the trainee health professional (nurse) 110.
3. Physiological Measurement: The open loop system 700 continuously records physiological signals 107 (such as electrodermal activity (EDA), heart rate variability (HRV), and other relevant indicators) from the trainee health professional (nurse) 110. These physiological metrics are used for analysis, but unlike in the closed loop system 100, do not directly influence or modify the behavior of the AIHT platform 102 during the training session.
4. Performance Data: The system 700 records performance metrics captured by the real-time performance data module 106 such as reaction time, decision accuracy, and other performance indicators during the decision-making process. This data is used for post-session analysis but does not impact the training flow or scenario adjustments in real-time, unlike the closed loop system 700.

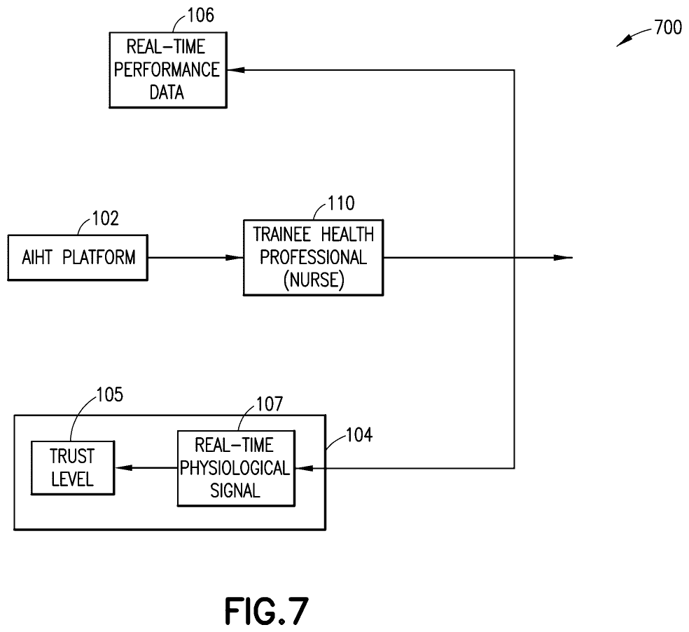

FIG. 8 is an example apparatus 800, which may be implemented in hardware, configured to implement the examples described herein. The apparatus 800 comprises at least one processor 802 (for example a field-programmable gate array (FPGA) and/or CPU and/or GPU), one or more memories 804 including computer program code 805, the computer program code 805 having instructions to carry out the methods described herein, wherein the at least one memory 804 and the computer program code 805 are configured to, with the at least one processor 802, cause the apparatus 800 to implement circuitry, a process, component, module, or function (implemented with control module 806) to implement the examples described herein. The one or more memories 804 may include a non-transitory memory, a transitory memory, a volatile memory (for example random access memory (RAM)), or a non-volatile memory (for example read-only memory (ROM)).

As shown in FIG. 8, apparatus 800 implements the AIHT platform 102, and the AIHT platform 102 is part of control module 806.

The apparatus 800 includes a display and/or I/O and user interface (UI) circuitry and elements 808, that may be used (for example via I/O interface 832) to display aspects or a status of the methods described herein (for example, as one of the methods is being performed or at a subsequent time), or to receive input from a user such as with using a keypad, camera, touchscreen, touch area, microphone, biometric recognition, one or more sensors, etc. The apparatus 800 includes one or more communications, for example network (N/W) interfaces (I/F(s)) 810 (or communication I/F(s)). The communication I/F(s) 810 may be wired and/or wireless and communicate over the Internet/other network(s) via any communication technique including via one or more links 824. The communication I/F(s) 810 may comprise one or more transmitters or one or more receivers.

The transceiver 816 comprises one or more transmitters 818 and one or more receivers 820. The transceiver 816 and/or communication I/F(s) 810 may comprise standard well-known components such as an amplifier, filter, frequency-converter, (de)modulator, and encoder/decoder circuitries and one or more antennas, such as antennas 814 used for communication over wireless link 826.

The control module 806 of the apparatus 800 comprises one of or both parts 806-1 and/or 806-2, which may be implemented in a number of ways. The control module 806 may be implemented in hardware as control module 806-1, such as being implemented as part of the one or more processors 802. The control module 806-1 may be implemented also as an integrated circuit or through other hardware such as a programmable gate array. In another example, the control module 806 may be implemented as control module 806-2, which is implemented as computer program code (having corresponding instructions) 805 and is executed by the one or more processors 802. For instance, the one or more memories 804 store instructions that, when executed by the one or more processors 802, cause the apparatus 800 to perform one or more of the operations as described herein. Furthermore, the one or more processors 802, the one or more memories 804, and example algorithms (for example, as flowcharts and/or signaling diagrams), encoded as instructions, programs, or code, are means for causing performance of the operations described herein.

The apparatus 800 may be distributed throughout a network including within and between apparatus 800 and any network element (such as a network control element (NCE) a radio access network (RAN) node and/or a user equipment).

Interface 812 enables data communication and signaling between the various items of apparatus 800, as shown in FIG. 8. For example, the interface 812 may be one or more buses such as address, data, or control buses, and may include any interconnection mechanism, such as a series of lines on a motherboard or integrated circuit, fiber optics or other optical communication equipment, and the like. Computer program code (for example instructions) 805, including control of control module 806 may comprise object-oriented software configured to pass data or messages between objects within computer program code 805, or computer program code (for example instructions) 805, including control of control module 806 may include functional, scripting, or procedural code. The apparatus 800 need not comprise each of the features mentioned, or may comprise other features as well. The various components of apparatus 800 may at least partially reside in a common housing 828, or a subset of the various components of apparatus 800 may at least partially be located in different housings, which different housings may include housing 828.

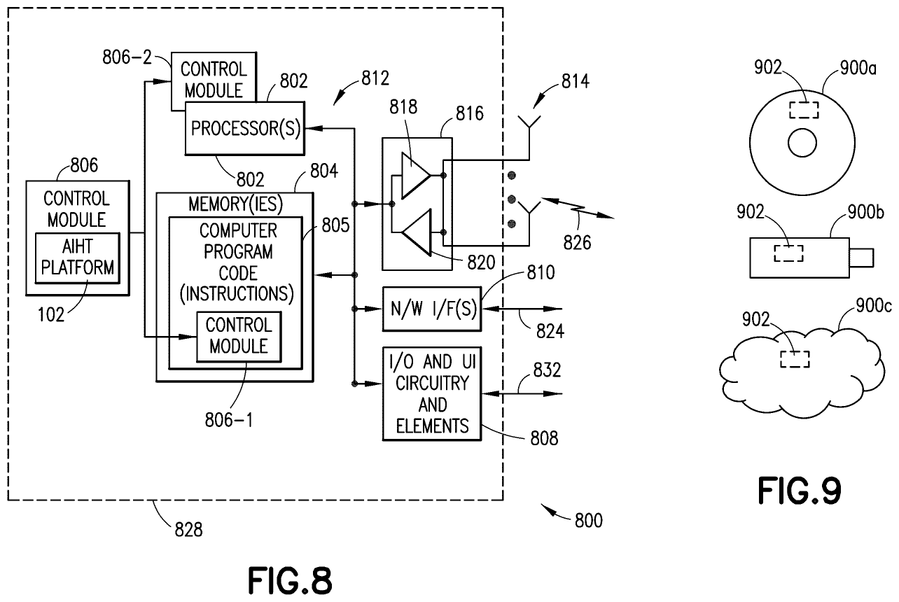

FIG. 9 shows a schematic representation of non-volatile memory media 900a (for example computer/compact disc (CD) or digital versatile disc (DVD)) and 900b (for example universal serial bus (USB) memory stick) and 900c (for example cloud storage for downloading instructions and/or parameters 902 or receiving emailed instructions and/or parameters 902) storing instructions and/or parameters 902 which when executed by a processor allows the processor to perform one or more of the steps of the methods described herein. Instructions and/or parameters 902 may represent a computer readable medium.

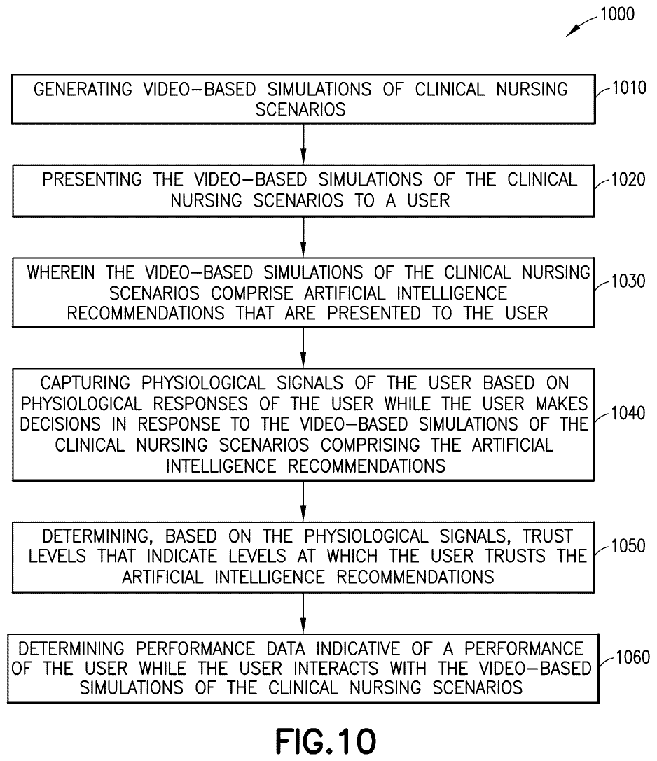

FIG. 10 is an example method 1000 that implements the examples described herein. Item 1010 of method is generating video-based simulations of clinical nursing scenarios, where the video-based simulations of the clinical nursing scenarios are generated by expert instructed AI generation, or the video-based simulations of the clinical nursing scenarios are expertly curated videos. Item 1020 of the method is presenting the video-based simulations of the clinical nursing scenarios to a user. item 1030 of the method is wherein the video-based simulations of the clinical nursing scenarios comprise artificial intelligence recommendations that are presented to the user. Item 1040 of the method is capturing physiological signals of the user based on physiological responses of the user while the user makes decisions in response to the video-based simulations of the clinical nursing scenarios comprising the artificial intelligence recommendations. Item 1050 of the method is determining, based on the physiological signals, trust levels that indicate levels at which the user trusts the artificial intelligence recommendations. Item 1060 of the method is determining performance data indicative of a performance of the user while the user interacts with the video-based simulations of the clinical nursing scenarios. Method 1000 may be implemented with AIHT platform 102.

In an implementation, an apparatus includes at least one processor, and at least one memory storing instructions that, when executed by the at least one processor, cause the apparatus at least to: generate video-based simulations of clinical nursing scenarios, present the video-based simulations of the clinical nursing scenarios to a user, wherein the video-based simulations of the clinical nursing scenarios comprise artificial intelligence recommendations that are presented to the user, capture physiological signals of the user based on physiological responses of the user while the user makes decisions in response to the video-based simulations of the clinical nursing scenarios comprising the artificial intelligence recommendations, determine, based on the physiological signals, trust levels that indicate levels at which the user trusts the artificial intelligence recommendations, and determine performance data indicative of a performance of the user while the user interacts with the video-based simulations of the clinical nursing scenarios.

In implementation, the at least one memory stores instructions that, when executed by the at least one processor, cause the apparatus at least to: correlate the trust levels that indicate levels at which the user trusts the artificial intelligence recommendations with the performance data associated with a performance of the user while the user interacts with the video-based simulations of the clinical nursing scenarios.

In an implementation, the at least one memory stores instructions that, when executed by the at least one processor, cause the apparatus at least to: adjust the artificial intelligence recommendations provided during the video-based simulations based on the trust levels that indicate the levels at which the user trusts the artificial intelligence recommendations.

In an implementation, the at least one memory stores instructions that, when executed by the at least one processor, cause the apparatus at least to: adjust the artificial intelligence recommendations provided during the video-based simulations based on the performance data indicative of the performance of the user while the user interacts with the video-based simulations of the clinical nursing scenarios.

In an implementation, the at least one memory stores instructions that, when executed by the at least one processor, cause the apparatus at least to: adjust, based on the trust levels that indicate the levels at which the user trusts the artificial intelligence recommendations, at least one of: a difficulty of the clinical nursing scenarios presented within the video-based simulations, a frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations, and adjust, based on the performance data indicative of the performance of the user while the user interacts with the video-based simulations of the clinical nursing scenarios, at least one of: the difficulty of the clinical nursing scenarios presented within the video-based simulations, the frequency with which the artificial intelligence recommendations are provided within the video-based simulations of the clinical nursing scenarios, the time constraints for the user to make the decisions in response to the video-based simulations of the clinical nursing scenarios comprising the artificial intelligence recommendations, the confidence indicators provided within the video-based simulations that indicate confidence levels of the artificial intelligence recommendations, or the transparency of explanations provided within the video-based simulations.

In an implementation, the at least one memory stores instructions that, when executed by the at least one processor, cause the apparatus at least to: provide a benchmark from a reference performance database for evaluating the performance of the user while the user interacts with the video-based simulations of the clinical nursing scenarios, compare the performance of the user while the user interacts with the video-based simulations of the clinical nursing scenarios to the benchmark, and generate feedback for the user based on the comparison of the performance of the user while the user interacts with the video-based simulations of the clinical nursing scenarios to the benchmark, wherein the feedback for the user generated based on the comparison of the performance of the user while the user interacts with the video-based simulations of the clinical nursing scenarios to the benchmark indicates areas of improvement for the user, wherein the feedback for the user based on the comparison of the performance of the user while the user interacts with the video-based simulations of the clinical nursing scenarios to the benchmark reinforces correct decisions made by the user.

In an implementation, the physiological signals of the user are received from at least one wearable biosensor worn by the user while the user interacts with the video-based simulations of the clinical nursing scenarios, the physiological signals are indicative of at least one of a stress level of the user, a cognitive load of the user, at least one emotional response of the user, or user trust dynamics, and the physiological signals comprise at least one of electrodermal activity or heart rate variability.

The performance associated with the performance of the user while the user interacts with the video-based simulations of the clinical nursing scenarios comprises at least one of: a reaction time of the user, or an accuracy of the decisions made by the user in response to the video-based simulations of the clinical nursing scenarios comprising the artificial intelligence recommendations, or a problem solving performance of the user.

In an implementation, the trust levels that indicate the levels at which the user trusts the artificial intelligence recommendations are further determined based on at least one of the following: at least one pattern comprising how often the user follows the artificial intelligence recommendations, or a frequency of which the user interacts with the artificial intelligence recommendations.

In an implementation, a method includes generating video-based simulations of clinical nursing scenarios, presenting the video-based simulations of the clinical nursing scenarios to a user, wherein the video-based simulations of the clinical nursing scenarios comprise artificial intelligence recommendations that are presented to the user, capturing physiological signals of the user based on physiological responses of the user while the user makes decisions in response to the video-based simulations of the clinical nursing scenarios comprising the artificial intelligence recommendations, determining, based on the physiological signals, trust levels that indicate levels at which the user trusts the artificial intelligence recommendations, and determining performance data indicative of a performance of the user while the user interacts with the video-based simulations of the clinical nursing scenarios. In an implementation, the video-based simulations of the clinical nursing scenarios that include the artificial intelligence recommendations is expert based curated video or AI expert generated videos. In an implementation, a non-transitory computer readable medium includes instructions stored thereon that are configured to execute the method.

In an implementation, the method further includes correlating the trust levels that indicate levels at which the user trusts the artificial intelligence recommendations with the performance data indicative of the performance of the user while the user interacts with the video-based simulations of the clinical nursing scenarios.

In an implementation, the method further includes adjusting the artificial intelligence recommendations provided during the video-based simulations based on the trust levels that indicate the levels at which the user trusts the artificial intelligence recommendations, and adjusting the artificial intelligence recommendations provided during the video-based simulations based on the performance data indicative of the performance of the user while the user interacts with the video-based simulations of the clinical nursing scenarios.

In an implementation, the method further includes adjusting, based on the trust levels that indicate the levels at which the user trusts the artificial intelligence recommendations, at least one of: a difficulty of the clinical nursing scenarios presented within the video-based simulations, a frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations, and adjusting, based on the performance data indicative of the performance of the user while the user interacts with the video-based simulations of the clinical nursing scenarios, at least one of: the difficulty of the clinical nursing scenarios presented within the video-based simulations, the frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations.

In an implementation, the method further includes providing a benchmark from a reference performance database for evaluating the performance of the user while the user interacts with the video-based simulations of the clinical nursing scenarios, comparing the performance of the user while the user interacts with the video-based simulations of the clinical nursing scenarios to the benchmark, and generating feedback for the user based on the comparison of the performance of the user while the user interacts with the video-based simulations of the clinical nursing scenarios to the benchmark, wherein the feedback for the user generated based on the comparison of the performance of the user while the user interacts with the video-based simulations of the clinical nursing scenarios to the benchmark indicates areas of improvement for the user, wherein the feedback for the user based on the comparison of the performance of the user while the user interacts with the video-based simulations of the clinical nursing scenarios to the benchmark reinforces correct decisions made by the user.

In an implementation, the physiological signals of the user are received from at least one wearable biosensor worn by the user while the user interacts with the video-based simulations of the clinical nursing scenarios, the physiological signals are indicative of at least one of a stress level of the user, a cognitive load of the user, at least one emotional response of the user, or user trust dynamics, and the physiological signals comprise at least one of electrodermal activity or heart rate variability.

In an implementation, the performance associated with the performance of the user while the user interacts with the video-based simulations of the clinical nursing scenarios includes at least one of: a reaction time of the user, or an accuracy of the decisions made by the user in response to the video-based simulations of the clinical nursing scenarios comprising the artificial intelligence recommendations, or a problem solving performance of the user.

In an implementation, the trust levels that indicate the levels at which the user trusts the artificial intelligence recommendations are further determined based on at least one of the following: at least one pattern comprising how often the user follows the artificial intelligence recommendations, or a frequency of which the user interacts with the artificial intelligence recommendations.

In an implementation, a system includes a healthcare technology platform configured to generate video-based simulations of clinical nursing scenarios and present the video-based simulations of the clinical nursing scenarios to a user, wherein the video-based simulations of the clinical nursing scenarios comprise artificial intelligence recommendations that are presented to the user using the healthcare technology platform, a real-time physiological module configured to measure physiological signals of the user based on physiological responses of the user while the user makes decisions in response to the video-based simulations of the clinical nursing scenarios comprising the artificial intelligence recommendations, wherein the real-time physiological module is configured to determine, based on the physiological signals, trust levels that indicate levels at which the user trusts the artificial intelligence recommendations, and a real-time performance data module configured to determine performance data indicative of a performance of the user while the user interacts with the video-based simulations of the clinical nursing scenarios.

In an implementation, the system further includes an intelligent adaptive modulator engine configured to: adjust the artificial intelligence recommendations provided during the video-based simulations based on the trust levels that indicate the levels at which the user trusts the artificial intelligence recommendations, adjust the artificial intelligence recommendations provided during the video-based simulations based on the performance data indicative of the performance of the user while the user interacts with the video-based simulations of the clinical nursing scenarios, adjust, based on the trust levels that indicate the levels at which the user trusts the artificial intelligence recommendations, at least one of: a difficulty of the clinical nursing scenarios presented within the video-based simulations, a frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations, and adjust, based on the performance data indicative of the performance of the user while the user interacts with the video-based simulations of the clinical nursing scenarios, at least one of: the difficulty of the clinical nursing scenarios presented within the video-based simulations, the frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations.

In an implementation, the adjustments are made in real-time while the healthcare technology platform presents the video-based simulations of the clinical nursing scenarios to the user.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as interpretations as “means-plus-function” language unless specifically expressed as such by use of the words “means for” or “steps for” within the respective claim.

When introducing elements of the examples described herein or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. An apparatus comprising:
at least one processor, and
at least one memory storing instructions that, when executed by the at least one processor, cause the apparatus at least to:
generate video-based simulations of clinical nursing scenarios,
present the video-based simulations of the clinical nursing scenarios to a user,
wherein the video-based simulations of the clinical nursing scenarios comprise artificial intelligence recommendations that are presented to the user,
capture physiological signals of the user based on physiological responses of the user while the user makes decisions in response to the video-based simulations of the clinical nursing scenarios comprising the artificial intelligence recommendations,
determine, based on the physiological signals, trust levels that indicate levels at which the user trusts the artificial intelligence recommendations, and
determine performance data indicative of a performance of the user while the user interacts with the video-based simulations of the clinical nursing scenarios.

2. The apparatus of claim 1, wherein the at least one memory stores instructions that, when executed by the at least one processor, cause the apparatus at least to:
correlate the trust levels that indicate levels at which the user trusts the artificial intelligence recommendations with the performance data associated with a performance of the user while the user interacts with the video-based simulations of the clinical nursing scenarios.

3. The apparatus of claim 1, wherein the video-based simulations of the clinical nursing scenarios are generated by receiving expert instruction, and the video-based simulations of the clinical nursing scenarios include text comprising information related to diagnosis of a subject and performing an action to address a health related issue associated with the subject.

4. The apparatus of claim 1, wherein the at least one memory stores instructions that, when executed by the at least one processor, cause the apparatus at least to:
adjust the artificial intelligence recommendations provided during the video-based simulations based on the trust levels that indicate the levels at which the user trusts the artificial intelligence recommendations, and
adjust the artificial intelligence recommendations provided during the video-based simulations based on the performance data indicative of the performance of the user while the user interacts with the video-based simulations of the clinical nursing scenarios.

5. The apparatus of claim 1, wherein the at least one memory stores instructions that, when executed by the at least one processor, cause the apparatus at least to:
adjust, based on the trust levels that indicate the levels at which the user trusts the artificial intelligence recommendations, at least one of: a difficulty of the clinical nursing scenarios presented within the video-based simulations, a frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations, and
adjust, based on the performance data indicative of the performance of the user while the user interacts with the video-based simulations of the clinical nursing scenarios, at least one of: the difficulty of the clinical nursing scenarios presented within the video-based simulations, the frequency with which the artificial intelligence recommendations are provided within the video-based simulations of the clinical nursing scenarios, the time constraints for the user to make the decisions in response to the video-based simulations of the clinical nursing scenarios comprising the artificial intelligence recommendations, the confidence indicators provided within the video-based simulations that indicate confidence levels of the artificial intelligence recommendations, or the transparency of explanations provided within the video-based simulations.

6. The apparatus of claim 1, wherein the at least one memory stores instructions that, when executed by the at least one processor, cause the apparatus at least to:
provide a benchmark from a reference performance database for evaluating the performance of the user while the user interacts with the video-based simulations of the clinical nursing scenarios,
compare the performance of the user while the user interacts with the video-based simulations of the clinical nursing scenarios to the benchmark, and
generate feedback for the user based on the comparison of the performance of the user while the user interacts with the video-based simulations of the clinical nursing scenarios to the benchmark,
wherein the feedback for the user generated based on the comparison of the performance of the user while the user interacts with the video-based simulations of the clinical nursing scenarios to the benchmark indicates areas of improvement for the user,
wherein the feedback for the user based on the comparison of the performance of the user while the user interacts with the video-based simulations of the clinical nursing scenarios to the benchmark reinforces correct decisions made by the user.

7. The apparatus of claim 1, wherein:
the physiological signals of the user are received from at least one wearable biosensor worn by the user while the user interacts with the video-based simulations of the clinical nursing scenarios,
the physiological signals are indicative of at least one of a stress level of the user, a cognitive load of the user, at least one emotional response of the user, or user trust dynamics, and
the physiological signals comprise at least one of electrodermal activity or heart rate variability.

8. The apparatus of claim 1, wherein the performance associated with the performance of the user while the user interacts with the video-based simulations of the clinical nursing scenarios comprises at least one of:
a reaction time of the user, or
an accuracy of the decisions made by the user in response to the video-based simulations of the clinical nursing scenarios comprising the artificial intelligence recommendations, or
a problem solving performance of the user.

9. The apparatus of claim 1, wherein the trust levels that indicate the levels at which the user trusts the artificial intelligence recommendations are further determined based on at least one of the following:
at least one pattern comprising how often the user follows the artificial intelligence recommendations, or
a frequency of which the user interacts with the artificial intelligence recommendations.

10. A method comprising:
generating video-based simulations of clinical nursing scenarios,
presenting the video-based simulations of the clinical nursing scenarios to a user,
wherein the video-based simulations of the clinical nursing scenarios comprise artificial intelligence recommendations that are presented to the user,
capturing physiological signals of the user based on physiological responses of the user while the user makes decisions in response to the video-based simulations of the clinical nursing scenarios comprising the artificial intelligence recommendations,
determining, based on the physiological signals, trust levels that indicate levels at which the user trusts the artificial intelligence recommendations, and
determining performance data indicative of a performance of the user while the user interacts with the video-based simulations of the clinical nursing scenarios.

11. The method of claim 10, further comprising:
correlating the trust levels that indicate levels at which the user trusts the artificial intelligence recommendations with the performance data indicative of the performance of the user while the user interacts with the video-based simulations of the clinical nursing scenarios.

12. The method of claim 10, further comprising:
adjusting the artificial intelligence recommendations provided during the video-based simulations based on the trust levels that indicate the levels at which the user trusts the artificial intelligence recommendations, and
adjusting the artificial intelligence recommendations provided during the video-based simulations based on the performance data indicative of the performance of the user while the user interacts with the video-based simulations of the clinical nursing scenarios.

13. The method of claim 10, further comprising:
adjusting, based on the trust levels that indicate the levels at which the user trusts the artificial intelligence recommendations, at least one of: a difficulty of the clinical nursing scenarios presented within the video-based simulations, a frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations, and
adjusting, based on the performance data indicative of the performance of the user while the user interacts with the video-based simulations of the clinical nursing scenarios, at least one of: the difficulty of the clinical nursing scenarios presented within the video-based simulations, the frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations.

14. The method of claim 10, further comprising:
providing a benchmark from a reference performance database for evaluating the performance of the user while the user interacts with the video-based simulations of the clinical nursing scenarios,
comparing the performance of the user while the user interacts with the video-based simulations of the clinical nursing scenarios to the benchmark, and
generating feedback for the user based on the comparison of the performance of the user while the user interacts with the video-based simulations of the clinical nursing scenarios to the benchmark,
wherein the feedback for the user generated based on the comparison of the performance of the user while the user interacts with the video-based simulations of the clinical nursing scenarios to the benchmark indicates areas of improvement for the user,
wherein the feedback for the user based on the comparison of the performance of the user while the user interacts with the video-based simulations of the clinical nursing scenarios to the benchmark reinforces correct decisions made by the user.

15. The method of claim 10, wherein:
the physiological signals of the user are received from at least one wearable biosensor worn by the user while the user interacts with the video-based simulations of the clinical nursing scenarios,
the physiological signals are indicative of at least one of a stress level of the user, a cognitive load of the user, at least one emotional response of the user, or user trust dynamics, and
the physiological signals comprise at least one of electrodermal activity or heart rate variability.

16. The method of claim 10, wherein the performance associated with the performance of the user while the user interacts with the video-based simulations of the clinical nursing scenarios comprises at least one of:
a reaction time of the user, or
an accuracy of the decisions made by the user in response to the video-based simulations of the clinical nursing scenarios comprising the artificial intelligence recommendations, or
a problem solving performance of the user.

17. The method of claim 10, wherein the trust levels that indicate the levels at which the user trusts the artificial intelligence recommendations are further determined based on at least one of the following:
at least one pattern comprising how often the user follows the artificial intelligence recommendations, or
a frequency of which the user interacts with the artificial intelligence recommendations.

18. A system comprising:
a healthcare technology platform configured to generate video-based simulations of clinical nursing scenarios and present the video-based simulations of the clinical nursing scenarios to a user,
wherein the video-based simulations of the clinical nursing scenarios comprise artificial intelligence recommendations that are presented to the user using the healthcare technology platform,
a real-time physiological module configured to measure physiological signals of the user based on physiological responses of the user while the user makes decisions in response to the video-based simulations of the clinical nursing scenarios comprising the artificial intelligence recommendations,
wherein the real-time physiological module is configured to determine, based on the physiological signals, trust levels that indicate levels at which the user trusts the artificial intelligence recommendations, and
a real-time performance data module configured to determine performance data indicative of a performance of the user while the user interacts with the video-based simulations of the clinical nursing scenarios.

19. The system of claim 18, further comprising an intelligent adaptive modulator engine configured to:
adjust the artificial intelligence recommendations provided during the video-based simulations based on the trust levels that indicate the levels at which the user trusts the artificial intelligence recommendations,
adjust the artificial intelligence recommendations provided during the video-based simulations based on the performance data indicative of the performance of the user while the user interacts with the video-based simulations of the clinical nursing scenarios,
adjust, based on the trust levels that indicate the levels at which the user trusts the artificial intelligence recommendations, at least one of: a difficulty of the clinical nursing scenarios presented within the video-based simulations, a frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations, and
adjust, based on the performance data indicative of the performance of the user while the user interacts with the video-based simulations of the clinical nursing scenarios, at least one of: the difficulty of the clinical nursing scenarios presented within the video-based simulations, the frequency with which the artificial intelligence recommendations are provided within the video-based simulations of the clinical nursing scenarios, time constraints for the user to make the decisions in response to the video-based simulations of the clinical nursing scenarios comprising the artificial intelligence recommendations, confidence indicators provided within the video-based simulations that indicate confidence levels of the artificial intelligence recommendations, or a transparency of explanations provided within the video-based simulations.

20. The system of claim 18, wherein the adjustments are made in real-time while the healthcare technology platform presents the video-based simulations of the clinical nursing scenarios to the user.
